(19) United States
(12) Patent Application Publication
(10) Pub. No.: US 2008/0027995 A1
(43) Pub. Date: Jan. 31, 2008

(54) Systems and methods for survey scheduling and implementation

(75) Inventor: Douglas A. Beigel, West Friendship, MD (US)

Correspondence Address: Gary M. Nath;THE NATH LAW GROUP, 112 South West Street, Alexandria, VA, 22314, US

(73) Assignee: COLA, Columbia, MD (US)

(21) Appl. No.: 11/905,032

(22) Filed: Sep. 27, 2007

Related U.S. Application Data
(63) Continuation-in-part of application No. 10/665,511, filed on Sep. 22, 2003.
(60) Provisional application No. 60/411,865, filed on Sep. 20, 2002.
(60) Provisional application No. 60/900,330, filed on Feb. 9, 2007.

(51) Int. Cl. G06F 17/30

(52) U.S. Cl. 707/104.1; 707/3; 715/779; 715/810

(57) ABSTRACT

An apparatus for assisting a user in scheduling a plurality of facilities for a survey includes: a storage device having a first database of entries representing facilities, geographical locations of facilities, and data representing ranking factors; a second database representing surveyors; a computer processor configured to estimate the time it would take for each of the facilities to be surveyed and to calculate a ranking for each of the facilities formed from ranking factors and to select a subset of facilities based on the ranking; a display unit capable of representing the subset; and, a human-machine interface configured with the processor to enable the user to select at least a facility from a subset and add it to a tour list and to schedule an order in which the facilities in the tour list will be visited by a surveyor from the second database. Related methods and systems are also described.

### CROSS-REFERENCE TO RELATED APPLICATIONS

This application is a continuation-in-part of U.S. patent application Ser. No. 10/665,511 filed Sep. 22, 2003, currently pending, which itself claims the benefit of U.S. Provisional Patent Application No. 60/411,865, filed Sep. 20, 2002. Further, this application claims the benefit of U.S. Provisional Patent Application No. 60/900,330, filed Feb. 9, 2007. The contents of these U.S. patent applications, Ser. Nos. 10/665,511, 60/411,865, and 60/900,330, are hereby incorporated by reference in their entirety.

### BACKGROUND OF THE INVENTION

1. Field of the Invention

Generally, the present invention relates to surveying, and more particularly to evaluation, assessment and certification systems and methods with integrated survey scheduling and version tracking.

2. Related Art

In today's technological climate, traditional assessment/certifying competency and compliance organizations are limited by their physical resources and monetary constraints. These organizations (e.g., educational organizations, nation-states, government agencies/ministries, professional societies, international/national standards setting organizations, surveying/inspection organizations and the like) have a relatively small consumer base (as exemplified by the limited number of participants), with generally fixed schedules, low availability of infrastructure funds, lack of scalability, and lack of custom approaches. These consumer-level concerns have limited the rate of advancement of traditional assessment/certifying competency and compliance models. Currently, these models are mostly paper-based systems that include a single assessment/certifying competency and compliance organization, and many participants. As such, current assessment/certifying competency and compliance models use methods and systems that many consider to be outdated.

Existing systems, methods, and computer-based apparatuses for assessment/certifying competency and compliance, where they even exist, are deficient in a number of areas. The existing systems, methods, and computer programs fail to provide an integrated interface for scheduling tours of facilities seeking assessment or compliance certification, let alone an interface which accounts for factors such as, as non-limiting examples, the locations of facilities, the availability of surveyors, or the availability of systems for performing tests.

Further, the existing systems, methods, and computer-based apparatuses also fail to track different versions of surveys and questions which may be simultaneously or sequentially given to a participant or facility.

Further, the existing systems, methods, and computer-based apparatuses also often fail to synchronize data from remote locations, or to integrate with customer relationship databases and accounting programs.

### SUMMARY OF THE INVENTION

The present subject matter meets the above-identified needs by providing a collaborative assessment/certifying competency and compliance system, as well as a method and computer-based apparatus product for implementing innovative criteria fashioned into an electronic assessment/certifying competency and compliance learning experience that can be utilized at great distances. A plurality of participants can participate in the assessment/certifying competency and compliance learning experience asynchronously, and surveys may be scheduled for a wide variety of facilities and surveyors without confusion.

In one embodiment, an apparatus for assisting a user in scheduling a plurality of facilities for a survey includes at least one storage device. The storage device includes a first database of entries, each entry representing one of the facilities, each entry including data representing the geographical location of the facility, and each entry including data representing a plurality of ranking factors. The apparatus includes at least one storage device further comprising a second database of entries, each entry of the second device representing a surveyor. At least one computer processor is configured to estimate the time it would take for each of the facilities to be surveyed, and to calculate a ranking formed from at least one ranking factor for each of the facilities. The computer processor is further configured to select a subset of facilities based on this ranking. The apparatus includes a display unit capable of representing the subset, and a human-machine interface configured with the processor to enable the user to select at least one facility from the subset, add the selected facility to a tour list, and schedule an order in which the facilities within the tour list will be visited by at least one surveyor from the second database.

In some aspects, the display unit can be configured to show at least one ranking for each facility in the subset.

In some aspects, two or more computer processors may perform the responsibilities of the “processor” above, where one of the computer processors is configured to calculate the ranking and another of the computer processors is used in scheduling the subset of facilities.

In some aspects, a processor is configured to provide a suggested order in which the facilities within the tour list will be visited by at least one surveyor from the second database.

In some aspects, the ranking factor may be selected from the group consisting of: when the selected facility was last surveyed; when the selected facility was last surveyed by a healthcare organization accreditator; an estimate of the time needed to survey the selected facility; if the selected facility is considered Risk of Harm; if a complaint directed toward the selected facility was filed; if the selected facility must be scheduled as soon as possible; if the selected facility must be resurveyed; how much time has passed since the selected facility was entered into the database; if a selected surveyor is permitted to survey the selected facility; if a facility has already been scheduled; the distance from a location of a selected surveyor to the geographical location of the selected facility; what tests need to be performed at the selected facility; and, the availability of systems corresponding to the tests which need to be performed at the selected facility.

In some aspects, all of the following are ranking factors present in the first database: when the selected facility was last surveyed; when the selected facility was last surveyed by a healthcare organization accreditator; an estimate of the time needed to survey the selected facility; if the selected facility is considered Risk of Harm; if a complaint directed toward the selected facility was filed; if the selected facility must be scheduled as soon as possible; if the selected facility must be resurveyed; how much time has passed since the selected facility was entered into the database; if a selected surveyor is permitted to survey the selected facility; if a facility has already been scheduled; the distance from a location of a selected surveyor to the geographical location of the selected facility; what tests need to be performed at the selected facility; and, the availability of systems corresponding to the tests which need to be performed at the selected facility.

In some aspects, the apparatus may include a network access device, and a storage device may include a third database storing evaluation questions and assessment questions. Subsets of the evaluation and assessment questions may be combinable to form assessment courses. The computer processor or processors and the storage devices may be included in a server. At least one computer processor may be further configured to cause a graphical user interface to be displayed via the network access device connected to the server and to the communications network. At least one computer processor may be further configured to present to a remote user terminal, via the graphical user interface, questions from at least one assessment course; to receive responses from the remote user terminal to questions of the assessment course; and to score the plurality of responses in order to determine whether the facility user should receive a certification for the assessment course

In some aspects, the apparatus includes a synchronizing interface for synchronizing data acquired at a surveyed facility with the entry representing the surveyed facility within the first database.

In some aspects, the apparatus includes a customer relationship database stored on a storage device and integrated with one of the databases.

In some aspects, the apparatus includes an accounting database stored on a storage device and integrated with one of the databases.

The present disclosure is also drawn to a method of assisting a user in scheduling a plurality of facilities for a survey. The method involves: providing the user with a first database of entries representing facilities, including data representing the geographical location of the facilities, and including data representing a plurality of ranking factors; estimating the time it would take for each of the facilities to be surveyed; providing the user with a second database of entries representing surveyors; calculating for the facilities a ranking formed from one or more of the ranking factors; forming a subset of facilities based at least on the ranking; providing the user with a display representing the subset; providing the user with an interface to select at least one facility from the subset and add it to a tour list; and providing the user with an interface to schedule an order in which the facilities from the tour list will be visited by at least one surveyor from the second database.

In some aspects, the method includes: storing evaluation and assessment questions, wherein subsets of which are combinable to form assessment courses; causing a graphical user interface to be displayed, over a communications network, to a facility user at a facility selected from within the tour list; receiving a selection from the facility user, via the graphical user interface, wherein the selection initiates one of the assessment courses; presenting to the facility user, via the graphical user interface, a subset of said evaluation and assessment questions comprised by the initiated assessment course; receiving responses from the facility user to the subset of evaluation and assessment questions; and scoring the responses in order to determine whether the facility user should receive a certification for the initiated assessment course.

In some aspects, the method includes: presenting to the facility user, via the graphical user interface, at least one evaluation or assessment question which is selected based on at least one of the facility user's previous responses.

In some aspects, instructions are stored on a machine readable medium for assisting a user in scheduling facilities for a survey according to the above method.

The present disclosure is also drawn to a system for assisting a user in scheduling a plurality of facilities for a survey. The system includes means for storing a first database of entries representing the facilities, including data representing the geographical location of the facilities, and including data representing ranking factors; means for estimating the time it would take for each of the facilities to be surveyed; means for storing a second database of entries representing the surveyors; means for calculating a ranking for one or more of the facilities formed from ranking factors; means for forming a subset of facilities based on the ranking; means for displaying the subset; means for selecting at least one facility from the subset to add to a tour list; and means for scheduling an order in which the facilities within the tour list will be visited by at least one surveyor from the second database.

The present disclosure is also drawn to a method for storing and presenting multiple surveys and questions. The method includes: storing questions and answers with question identifiers and answer identifiers, wherein subsets of the questions and answers are combinable to form question groups having question group identifiers and are further combinable to form assessment courses having assessment course identifiers; causing a graphical user interface to be displayed, over a communications network, to a user; presenting to the user, via the graphical user interface, a subset of questions comprised by at least one of the assessment courses; receiving responses from the user to the subset of questions; and scoring the responses based on answers corresponding to the questions in order to determine whether the user should receive a certification for the given assessment course. Question identifiers indicate logical relationships between presented questions and not presented questions. Question group identifiers indicate logical relationships between question groups and other question groups, and assessment course identifiers indicate logical relationships between the given assessment course and other assessment courses.

In some aspects, answer identifiers indicate logical relationships between (a) received answers to questions which were presented, and (b) stored answers to questions which were not presented.

In some aspects, a presented first assessment course is an older iteration of a second assessment course, and a score can be computed for the newer second assessment course based on responses from the older first assessment course by using the question identifiers, answer identifiers, question group identifiers, or assessment course identifiers.

In some aspects, a graphical user interface is displayed, over a communications network, to a second user; and questions from the second assessment course are presented to the second user via the graphical user interface. The second assessment course assesses the same subject matter as the first assessment course, and the two assessment courses can be presented simultaneously to the two users.

In some aspects, instructions are stored on a machine readable medium for storing and presenting multiple versions of surveys and questions given to a participant or facility according to the method.

Further features and advantages of the present subject matter as well as the structure and operation of various embodiments of the present subject matter are described in detail below with reference to the accompanying drawings.

### BRIEF DESCRIPTION OF THE DRAWINGS

FIG. 1 is a representation of an embodiment for an apparatus for assisting a user in scheduling a plurality of facilities for a survey.

FIG. 2 is a representation of the information stored on a storage device in an embodiment for an apparatus for assisting a user in scheduling a plurality of facilities for a survey.

FIG. 3 charts a method of assisting a user in scheduling a plurality of facilities for a survey.

FIG. 4 is a representation of the information stored on a storage device for a method of tracking different surveys and questions given to a participant or facility.

FIG. 5 charts a method of tracking different surveys and questions given to a participant or facility.

### DETAILED DESCRIPTION

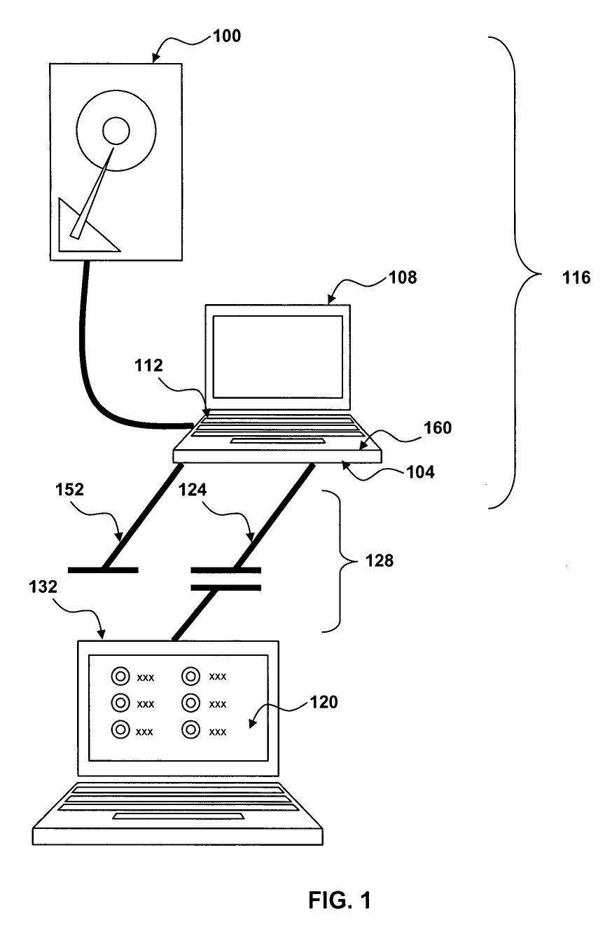

As shown in FIG. 1, the present subject matter provides an apparatus for assisting a user in scheduling a plurality of facilities for a survey. The apparatus may additionally be used for offering online, Web-based assessment/certifying competency and compliance evaluation and validation of these facilities.

The apparatus includes one or more storage devices 100 which can store databases. Although only one storage device 100 is shown, it should be noted that the multiple databases may be stored on multiple storage devices, or that a single database may be stored across multiple storage devices (in a RAID configuration or other known configurations for data or database storage), or that one database may comprise multiple sub-databases formed through linking. Although the storage device 100 is represented as a hard disk drive, this is only one storage medium for storing a database. It should be clear that many other storage devices are known in the art and may be used, including those based in flash-memory, and other magnetic devices such as tape drives. Although the storage device 100 is shown as being connected by hardware cabling to a computer processor 104, it should be clear that the database may be in communication with the computer processor in other manners, including wireless communication, remote communication over an intranet, or over the Internet.

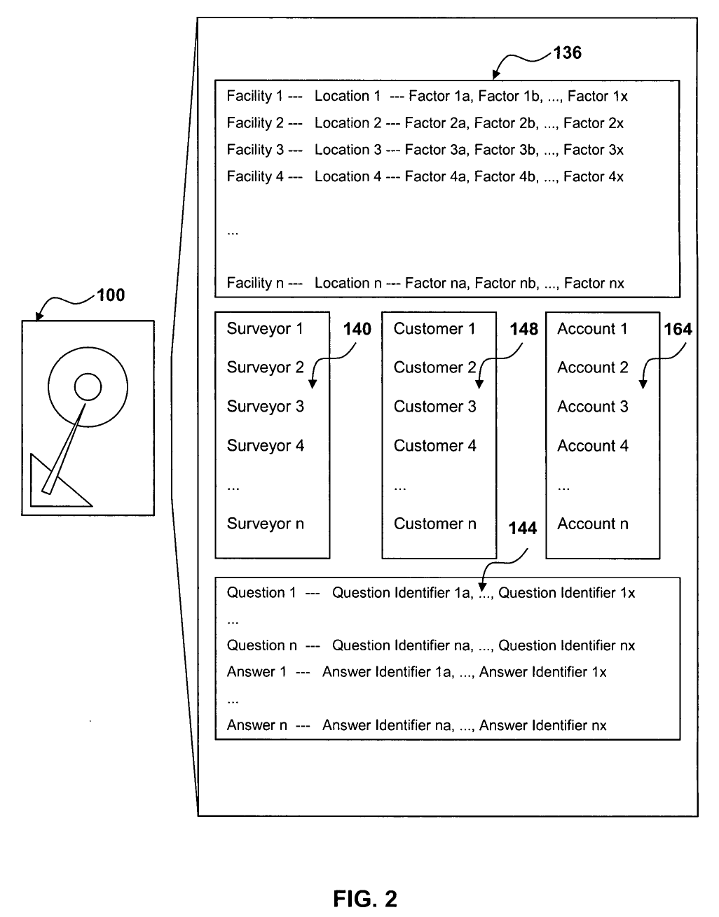

The storage device 100 stores databases used in assisting a user in scheduling a plurality of facilities for a survey. FIG. 2 is a representation of the information stored on storage device 100.

Making reference to FIG. 2, a first database 136 contains entries, each entry representing a facility. As non-limiting examples, the facility may be: a laboratory; a research facility or research institute; a hospital or other medical institution; a government facility; a college, university, high school, magnet school, charter school or other educational institution; an office; or any other institution which is to be scheduled for a survey. Each entry includes data representing the geographical location of a facility. This representation may be made in geometric coordinates, or in the form of an address which may be converted into general coordinates based on an atlas or mapping program.

Each entry in the first database on storage device 100 also includes data representing a plurality of ranking factors. Many factors may be useful in scheduling a facility for a survey, and the following sets forth ranking factors which have been determined to be helpful in efficient and effective scheduling. The following ranking factors are for illustrative purposes only, and are not meant to limit the scope of the present subject matter.

One ranking factor may be when the selected facility was last surveyed. As a non-limiting example, this ranking factor can aid in determining if the facility is due for a repeat survey, a rescheduled survey, or a new survey. As a further non-limiting example, this ranking factor can also aid in determining if the facility was surveyed at an appropriate time of day or year, based on the individuals and tools present at the facility or with the surveyor at that time. As a still further non-limiting example, this ranking factor can also aid in determining if the facility was just recently surveyed, and thus requires no attention for the time being.

Another ranking factor may be when the selected facility was last surveyed by a healthcare organization accreditator. As a non-limiting example, this accreditator may be the Joint Commission on Accreditation of Healthcare Organizations (JCAHO) or another accreditator. This ranking factor can aid in determining if the facility is due for a repeat survey, a rescheduled survey, or a new survey by a particular accreditator.

A further ranking factor may be if the selected facility is considered Risk of Harm. As non-limiting examples, this ranking factor can aid in determining if the facility is placing anyone at risk, or if the facility is currently under suspension or another form of observation, or if the facility requires multiple compliance checks before the Risk of Harm status may be removed.

A yet further ranking factor may be if a complaint directed toward the selected facility was filed. As non-limiting example, this ranking factor can aid in determining if the facility should be urgently surveyed, or if a third party should be notified of the performance or results of the survey upon completion thereof.

A still further ranking factor may be if the selected facility must for any other reason be scheduled as soon as possible, or stated alternatively, if the selected facility need not, or should not, be scheduled for a fixed period of time.

Another ranking factor may be if the selected facility must be resurveyed, based on the results of a previous survey or other information from an external survey.

A further ranking factor may be how much time has passed since the selected facility was entered into the database. As a non-limiting example, this ranking factor can aid in assessing if no action has been taken on the facility since its entry into the database.

A yet further ranking factor may be if a selected surveyor is permitted to survey the selected facility. As a non-limiting example, this ranking factor can aid in determining which surveyors can be sent to the facility, or stated alternatively, which surveyors or classes of surveyors are prohibited from surveying a particular facility.

Another ranking factor may be the distance from a location of a selected surveyor to the geographical location of the selected facility. This ranking factor may be calculated separately for each surveyor once the surveyor is selected, or may be stored for a finite number of surveyors, or may be calculated separately for a finite number of geographical regions into which the surveyors have been categorized. As a non-limiting example, this ranking factor can aid in determining whether it is convenient or even feasible in a given day for a selected surveyor to travel to or from the selected facility, and in determining which surveyor will be sent to each facility.

Another ranking factor may be what tests need to be performed at the selected facility. As non-limiting examples, this ranking factor can aid in determining which surveyors will be sent to the facility, what the surveyors may need to prepare for the survey, and what the surveyors will bring to the facility to perform the survey.

A further ranking factor may be the availability of systems corresponding to tests which need to be performed at the selected facility. As non-limiting examples, this ranking factor can aid in determining which surveyors will be sent to the facility, what the surveyors may need to prepare for the survey, and what the surveyors will bring to the facility to perform the survey.

A still further ranking factor may be if a facility has already been scheduled. As a non-limiting example, this ranking factor can aid in determining which facilities will be displayed to a user in preparing a future survey.

These are merely some of the ranking factors which may be utilized in performing a scheduling survey. Other ranking factors will be clear to those in the art which may be utilized, and by no means is the above list an exhaustive list.

The present disclosure does, however, disclose an aspect in which all of the above named ranking factors are present in the first database.

A second database 140 may also be stored on the storage device 100. The second database contains entries, each entry representing a surveyor. The term “surveyor” need not refer to an individual. The entries may represent individuals, teams, generic collections of characteristics (a “John Doe” surveyor), or even vehicles, tools, or other pieces of surveying equipment for which scheduling is desired. Although not shown, each entry may include factors about each surveyor, including a geographical location, the surveyor's hours of operation, the surveyor's qualifications, the surveyor's skills, the surveyor's potential conflicts of interest, or other factors.

Returning to FIG. 1, the apparatus includes one or more computer processors 104. Used here, the term “computer processor” need not refer only to a microprocessor. The processing functions noted below may be distributed across multiple processors or multiple processor cores, at the same or at different locations.

The processor 104 is configured to estimate the time it would take for each facility to be surveyed. The term “configured” may, as non-limiting examples, refer to the operation of software or firmware loaded into the processor 104, to the preconfiguration of the processor 104 as a chipset, or to the wiring of the processor 104 to one or more processors, storage devices, or network connections which allow the processor 104 to perform any task described herein, such as (as a non-limiting example) an estimation of the time it would take for each facility to be surveyed.

The processor 104 is further configured to calculate a ranking for a facility, wherein the ranking is formed from at least one factor as set forth above or another appropriate factor. The ranking may be a composite value based on numerical representations of the above factors, or may be an alert flag which is activated if one or more of the above factors exceeds a certain threshold.

The processor 104 is further configured to select a subset of facilities based on the ranking. This subset of facilities may be those which received the highest rankings, the lowest rankings, or a given selection or range of rankings. The ranking may, as non-limiting examples, represent the urgency with which a facility must be surveyed, the predicted difficulty of surveying the facility, or the proximity of the facility to a given or chosen surveyor at a point in a tour.

The apparatus includes a display unit 108 capable of representing the subset. The display unit 108 may be connected directly to the processor 104 at a personal computer or computer terminal. However, this is only one example, and many other configurations may be used. As non-limiting examples, the display unit 108 may receive instructions from a remote processor included in a server, over communication lines of an intranet or the Internet, or wirelessly. The display of the display unit 108 may comprise an Internet portal and/or a web browser.

The display unit 108 shows a representation of one or more facilities in the subset. Optionally, the display unit 108 may explicitly show at least one ranking for each facility in the subset. The ranking may be shown numerically, or in any other number of manners, such as by symbols, in color codes, in a hierarchy, or by word designations such as “high,” “medium,” and “low.” This is optional, however, and the ranking may be used merely to categorize the facilities in the subset before they are displayed; that is, the user need not be explicitly aware of the ranking.

The display unit 108 may provide a visualization tool for representing the facilities to be scheduled. As non-limiting examples, the facilities may be represented by icons on a map or grid. The icons may pictographically represent the facility type, and/or the color, size, or shape of the icons may represent one or more ranking for the facility. In one optional embodiment, the display unit 108 may send and receive instructions from a third-party visualization tool, such as a mapping software like Google Earth (a Registered Trademark of Google, Mountain View, Calif.). In such an embodiment, the processor 104 may be configured to provide information to, or receive information from, the third-party visualization tool, in order to together construct a visual representation of the facilities to be scheduled. By using a third-party visualization tool, information from the visualization tool's databases (such as mapping information, traffic information, road and route information, or population density information) may be utilized to assist in ranking or scheduling facilities. The visualization tool may optionally provide the screen through which the scheduler may use the human-machine interface 112, described below, to select a facility, review details of the facility, and/or add the facility to a schedule.

The apparatus includes a human-machine interface 112. The human-machine interface may be a keyboard, a mouse, a touchpad, or any number of interfaces with which a user may make a selection. Together with the computer processor 104, the human-machine interface 112 is configured for the user to select at least one facility from the subset and add it to a tour list, and configured for the user to schedule an order in which the facilities within the tour list will be visited by at least one surveyor. The user may view one or more of the factors on his display unit 108 in making his selection with the human-machine interface 112. As a non-limiting example, the order in which the facilities within the tour list will be visited may be based on at least the time it would take for each of the facilities to be surveyed. More generally, the options available to the user in scheduling the facilities may be based on the above estimate of time it would take for facilities to be surveyed, the above rankings, the above factors, and/or other factors such as time of day and display size.

The display sequence is not limited to the descriptions above. For example, the display unit 108 may show multiple permutations of surveyor-facility combinations. The processor 104 may be used to compute one or more suggested orders in which the facilities in the tour list might be visited by at least one surveyor from the second database. The display unit 108 may show these suggested orders, and may change the display based on selections made by the user. As a non-limiting example, the assignment of a surveyor to a facility or of a facility to a tour list may cause the processor 104 to recalculate the rankings based on the unassigned facilities and surveyors, and to reconfigure the display on the display unit 108 to present new orders.

As non-limiting examples, an embodiment of a scheduling process which the above apparatus may perform will now be described. The scheduling process may be performed through a user interface which allows a user to search for facilities initially based on a selected search location. This is referred to as a “cluster search.” The user can select to see facilities within 50, 100, and 150 miles of a location, a state, or a number of states. In addition, the user can choose to only include facilities of a given priority, ranking, or subset. The user may be able to select a targeted period for a survey. The priority may thus be in the perspective of this targeted period which the tour will span. The priority can filter out facilities which have already been scheduled but not yet surveyed.

With these filters in mind, the system displays the numbers of facilities within the distances specified in the areas selected, and also displays the priorities of facilities within these results. As an overview, this view need not give the facilities which are specifically related to these priorities and distances. Alerts which can also be set in another part of the scheduling system will also be displayed here if they are in the time period of the search, next to the location in the results. Additional alerts may be shown for whether facilities are in the same group, whether facilities are in close proximity to each other, and if facilities have unpaid bills. This overview also gives the scheduler the ability to select areas to drill down to a city level, or to view the facilities in the selected areas. The user can also see the facilities within a selected city area. When looking at the individual facilities within the drilled down results, alerts are attached to the individual facility records, and group and proximity information may reference specific facilities. At any point in this process, the scheduler can also opt to add these overview groups of facilities, or the individual facilities at the deepest level of the drilldown, to the tour.

After facilities have been added, additional information can be displayed about these facilities, as to when they were last surveyed, their survey units, and their location. This information can be used by the scheduler to additionally filter the facilities, and remove them from the tour. At this point, the scheduler can add facilities by the same method as aforementioned, or via a “manual method,” which is only a search by location, and does not have the information supplied through the cluster search. Once all the facilities have been added to a tour, the scheduler must finalize the tour, which triggers workflow tasks so that the surveyor knows to schedule these facilities on specific days within the tour.

The surveyor at this point can view the list of facilities in an interface which allows the selection of morning and afternoon time slots during days which the facilities are available in the tours time frame. The facilities are considered fully scheduled when their survey units are used up. This interface may also prohibit the surveyor from scheduling two facilities at the same time. In addition to this, there is also the ability to conduct a pseudo override of this limiting of the users actions, where the surveyor can add a facility to an additional time slot in a day.

To facilitate all of this, an interface can be provided to set all of the data used in generating the priorities, or the data may be provided automatically through system computation.

As noted above, the apparatus may additionally be used for offering online, Web-based assessment/certifying competency and compliance evaluation and validation of facilities.

Systems for performing these steps which are compatible with the presently disclosed systems and apparatuses are disclosed in U.S. Patent Application Publication No. 2004/0150662, which is incorporated by reference in its entirety.

To this effect, the above computer processor 104, storage device 100, display unit 108, and human-machine interface 112 may together be included in a server 116, and the computer processor 104 may be configured to present information such as assessment courses by way of a network communication device 124 over a communications network 128 to a remote user terminal 132. The information may be presented by the computer processor 104 via a graphical user interface 120. The computer processor 104 may be further configured to receive responses from the remote user terminal 132 to the questions of the assessment course. Although only one computer processor 104 and one remote user terminal 132 are shown, it should again be noted that the described methods of this application may be performed on multiple processors, such as on multiple processors or processor cores working in tandem at a single machine.

The term “assessment course” may refer to an established set of questions and question groups chosen to assess a particular subject area. However, this is only one kind of “assessment course,” and the term may also refer to an initially unestablished subset of questions and question groups, in which answers to initially provided questions form the basis for selecting further questions for presentation. In this way, the term “assessment course” can refer to a unique set of questions given to a particular remote user, where the questions provided are based in part on previous answers given by the user during the test. The questions chosen for the assessment course may also be selected on the basis of answers given to evaluation questions, and questions chosen for any evaluation course may also be selected on the basis of answers given to assessment questions.

Network communication device 124 allows software and data to be transferred between a computer system and external devices. Examples of network communication device 124 may include a modem, a network interface (such as an Ethernet card), a communications port, a Personal Computer Memory Card International Association (PCMCIA) slot and card, etc. Software and data transferred via network communication device 124 are in the form of signals which may be electronic, electromagnetic, optical or other signals capable of being received by network communication device 124. These signals are provided to network communication device 124 via a communications path (e.g., channel). As non-limiting examples, this path carries signals and maybe implemented using wire or cable, fiber optics, a telephone line, a cellular link, an radio frequency (RF) link and other communications channels.

The apparatus may include, as a software or hardware implementation, a workflow engine 160 which assures that one or more of the above steps are implemented according to stored workflow processes. These workflow processes may account for not only the surveying and scheduling steps described above, but also various other scheduling tasks and document routing tasks involved in an accreditation process.

When the apparatus is additionally used for offering online, Web-based assessment/certifying competency and compliance evaluation and validation of facilities, storage device 100 comprises a third database storing a plurality of evaluation questions and a plurality of assessment questions, wherein subsets of the plurality of evaluation and assessment questions are combinable to form a plurality of assessment courses such as the assessment course discussed above. This third database is represented in FIG. 2 as element 144.

An additional network communication device may also be used for other advantageous network communication with the computer processor 104, and for access to the storage device 100. The network communication device may, for example, be a synchronizing interface 152. A surveyor may access the synchronizing interface 152 by telephone, by Internet, or by physical connection, and may use the synchronizing interface 152 for synchronizing data acquired at a facility with the entry representing that facility within the first database of entries. Although this synchronizing interface is illustrated in FIG. 1. as a physical interface, it may also be provided as a software-based interface over existing network communication devices. Examples of the synchronizing interface 152 may include a modem, a network interface (such as an Ethernet card), a communications port, a Personal Computer Memory Card International Association (PCMCIA) slot and card, etc. Software and data transferred via the synchronizing interface 152 are in the form of signals which may be electronic, electromagnetic, optical or other signals capable of being received by the synchronizing interface 152. These signals are provided to the synchronizing interface 152 via a communications path (e.g., channel). As non-limiting examples, this channel carries signals and may be implemented using wire or cable, fiber optics, a telephone line, a cellular link, an radio frequency (RF) link, and/or other communications channels.

Referring again to FIG. 2, the storage device 100 may also include at least one customer relationship database 148 integrated with one or more of the other databases. In this way, customer relationship data on the surveyors, the facilities, the facility members or staff, and others may be used in the scheduling process. As a non-limiting example, additional factors may be used in ranking the facilities based on information in the customer relationship database, such as the length of time that has passed since a surveyor or facility employee has been last contacted, or alternate addresses and contact information for the surveyors or facilities. Similarly, information from the first or second database may be used to update records in the customer relationship database. As a non-limiting example, the customer relationship database may be updated to reflect work performed by a surveyor, and may include performance evaluations thereof. The integration of databases may be accomplished by any number of known protocols for data sharing.

The storage device 100 may also include an accounting database 164 integrated with one or more of the other databases. In this way, accounting data on the surveyors, the facilities, the facility members or staff, and others may be used in the scheduling process. As a non-limiting example, additional factors may be used in ranking the facilities based on information in the accounting database, such as whether a facility has an outstanding balance, or at what rate a surveyor is paid. Similarly, information from the first or second database may be used to update records in the accounting database. As a non-limiting example, the accounting database may be updated to reflect work performed by a surveyor, who may be paid accordingly, or may be updated to reflect a survey's completion at a facility, which may be billed accordingly. The integration of databases may be accomplished by any number of known protocols for data sharing.

More generally, the present subject matter provides a system for assisting a user in scheduling a plurality of facilities for a survey. The system comprises: means for providing the user with a first database of entries (as a non-limiting example, server 116 with storage device 100), each entry representing one of the plurality of facilities, including data representing the geographical location of one of the plurality of facilities, and including data representing a plurality of ranking factors; means for estimating the time it would take for each of the facilities to be surveyed (as a non-limiting example, computer processor 104); means for providing the user with a second database of entries, each entry representing one of a plurality of surveyors; means for providing the user with at least one ranking for at least one of the plurality of facilities, wherein the at least one ranking is formed from at least one of the plurality of ranking factors (as a non-limiting example, server 116 with storage device 100); means for forming a subset of the plurality of facilities based on the at least one ranking (as a non-limiting example, computer processor 104); means for providing the user with a display representing the subset, the display optionally showing at least one ranking for each facility in the subset (as a non-limiting example, computer processor 104 with display unit 108); means for providing the user with an interface to select at least one facility from the subset and add it to a tour list (as a non-limiting example, computer processor 104 with human-machine interface 112); and means for providing the user with an interface to schedule an order in which the facilities from the subset within the tour list will be visited by at least one surveyor (as a non-limiting example, computer processor 104 with human-machine interface 112). This is only one example of such a system, and other systems may be formed from elements discussed throughout this specification.

As a further non-limiting example, a system according to the present subject matter may include an end user (e.g., an individual, organization or surveyor user) who utilizes an access device to access the global, public Internet (and thus to browse the World Wide Web (WWW)). In alternate embodiments, the accessing device is a personal computer (PC) equipped with browser software. In alternate embodiments, accessing device is any processing device having a processor and a display including, but not limited to, a terminal, minicomputer, microcomputer, mainframe computer, laptop, palmtop, workstation, set-top box or personal digital assistant (PDA). Such a system may also include a Web server(s) and one or more databases. A web server provides the “front end” for a Web site operated by the assessment/certifying competency and compliance organization that allows access to its Web site over the Internet via one or more Uniform Resource Locator addresses (URLs). That is, a server contains a Web server process running at a Web site which sends out Web pages in response to Hypertext Transfer Protocol (HTTP) or Hypertext Transmission Protocol, Secured (HTTPS) requests from remote browsers (i.e., one or more users utilizing device(s)). More specifically, it provides graphical user interface (GUI) “front end” screens to users in the form of Web pages. These Web pages, when sent to a user's terminal (or the like), would result in GUI screens being displayed. In an embodiment, a server also contains software code logic that (is the “back-end” of system and) controls the evaluation, assessment and certification processes described herein. As a non-limiting example, the server may be a Sun® or Microsoft NT® workstation. The server may have access to one or more databases implemented with relational database management server software (e.g., Oracle® 9 RDBMS or the like). A database may be used as the central store for information within the system for the entity operating the Web site(s) hosted by server (e.g., login names, passwords, subscriber information, standards, criteria, evaluation and assessment questions, templates, scores, etc.). It will be apparent to one skilled in the relevant art(s) that a system according to the presently disclosed inventive subject matter may utilize databases physically located on one or more computers which may be the same as any of the server(s). A database can be mirrored for fault tolerance. It will be apparent to one skilled in the relevant art(s), after reading the description herein, that the systems illustrated herein are generally representative of a technical environment in which the present invention may operate. That is, the system illustration is not intended to limit the environment where the present invention may operate. In fact, it will be apparent to one skilled in the relevant art(s) that the present subject matter may be implemented in alternative environments (e.g., on an intranet, extranet, dial-up, LAN, WAN, or stand-alone system executing on a CD-ROM, etc.).

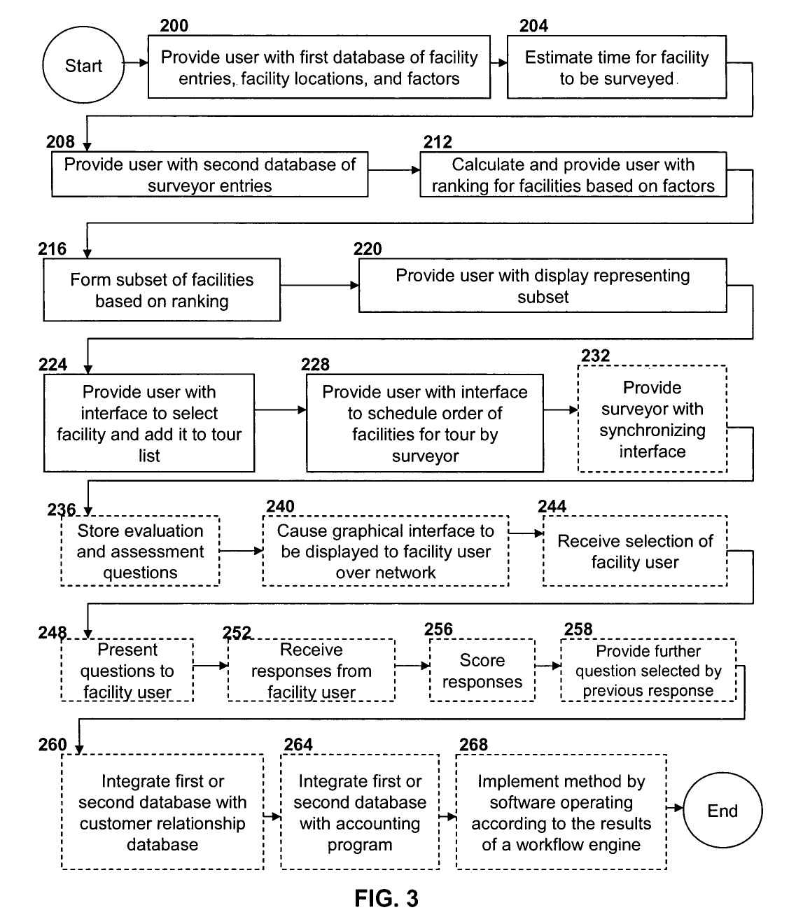

FIG. 3 charts in greater detail a method of assisting a user in scheduling a plurality of facilities for a survey. The method may be performed by the above apparatus or system, or by another appropriate apparatus or system. Importantly, while FIG. 3 illustrates one order of steps for performing the claimed method, other orders may be used, and the order of steps illustrated in FIG. 3 is a non-limiting example. With few exceptions, the claimed methods may be performed in any order of steps, and the subject matter is defined by the claims and their full scope of equivalence.

The method comprises (step 200) providing the user with a first database of entries, the contents of which are described above, and may include the factors listed above. The database may be provided through any number of interfaces, including those set forth above. The method further comprises (step 204) estimating the time it would take for each of the facilities to be surveyed. The method further comprises (step 208) providing the user with a second database of entries, each entry representing one of a plurality of surveyors. The method further comprises (step 212) providing the user with at least one ranking for a facility, wherein the ranking is formed from at least one of the factors. The method further comprises (step 216) forming a subset of facilities based on the ranking. The method further comprises (step 220) providing the user with a display representing the subset, the display showing at least one ranking for each facility in the subset. The method further comprises (step 224) providing the user with an interface to select at least one facility from the subset and add it to a tour list. The method further comprises (step 228) providing the user with an interface to schedule an order in which the facilities from the subset within the tour list will be visited by a surveyor. The options available to the user in scheduling the facilities may be based on the above estimate of time it would take for facilities to be surveyed, the above rankings, and/or the above factors.

As described in reference to the apparatus of FIG. 1, the method may include additional steps for offering online, Web-based assessment/certifying competency and compliance evaluation and validation of facilities. Methods for performing these steps which are compatible with the presently disclosed method are disclosed in U.S. Patent Application Publication No. 2004/0150662, which is incorporated by reference in its entirety.

The present subject matter may include optional steps within the method. As such, the method may further comprise (step 236) storing a plurality of evaluation questions and a plurality of assessment questions, wherein subsets of these plurality of evaluation and assessment questions are combinable to form assessment courses. These questions have been illustrated in FIG. 2 in third database 144, and are described in greater detail in the above-referenced specification. As noted above, the term “assessment course” may refer to an established set of questions and question groups chosen to assess a particular subject area, or may also refer to an initially unestablished subset of questions and question groups, in which answers to initially provided questions form the basis for selecting further questions for presentation.

The method may comprise (step 240) causing a graphical user interface to be displayed, over a communications network, to a facility user at a facility selected from within the tour list or from any other facility. The method may comprise (step 244) receiving a selection from the facility user, via the graphical user interface, wherein the selection initiates one of the plurality of assessment courses. The method may comprise (step 248) presenting to the facility user, via the graphical user interface, the subset of the plurality of evaluation and assessment questions comprising the initiated assessment course. The method may comprise (step 252) receiving responses from a facility user to the subset of the plurality of evaluation and assessment questions within the initiated assessment course. The method may comprise (step 256) scoring the plurality of responses in order to determine whether the facility user should receive a certification for the selected assessment course. The method may comprise (step 258) providing the facility user, via the graphical user interface, at least one question selected overtly or implicitly by at least one of the responses previously provided by the user.

The method may comprise (step 232) providing the surveyor with a synchronizing interface for synchronizing data acquired at a facility with an entry representing that facility within the first database of entries. Such synchronizing interfaces have been described above in reference to FIG. 1.

The method may comprise (step 260) integrating the first or second database with at least one customer relationship database. In this way, customer relationship data on the surveyors, the facilities, the facility members or staff, and others may be used in the scheduling process. As a non-limiting example, additional factors may be used in ranking the facilities based on information in the customer relationship database, such as the length of time that has passed since a surveyor or facility employee has been last contacted, or alternate addresses and contact information for the surveyors or facilities. Similarly, information from the first or second database may be used to update records in the customer relationship database. As a non-limiting example, the customer relationship database may be updated to reflect work performed by a surveyor, and may include performance evaluations thereof. The integration of databases may be accomplished by any number of known protocols for data sharing, and the databases may be stored on the same server or at different locations.

The method may comprise (step 264) integrating the first or second database with at least one accounting program. In this way, accounting data on the surveyors, the facilities, the facility members or staff, and others may be used in the scheduling process. As a non-limiting example, additional factors may be used in ranking the facilities based on information in the accounting program, such as whether a facility has an outstanding balance, or at what rate a surveyor is paid. Similarly, information from the first or second database may be used to update records in the accounting program. As a non-limiting example, the accounting program may be updated to reflect work performed by a surveyor, who may be paid accordingly, or may be updated to reflect a survey's completion at a facility, which may be billed accordingly. The integration of databases may be accomplished by any number of known protocols for data sharing, and the databases may be stored on the same server or at different locations.

The method may be implemented (step 268) by software operating according to the results of a workflow engine.

Again, as steps 232-268 are considered optional to the present subject matter, any or all of these steps may be present in the methods as discussed herein.

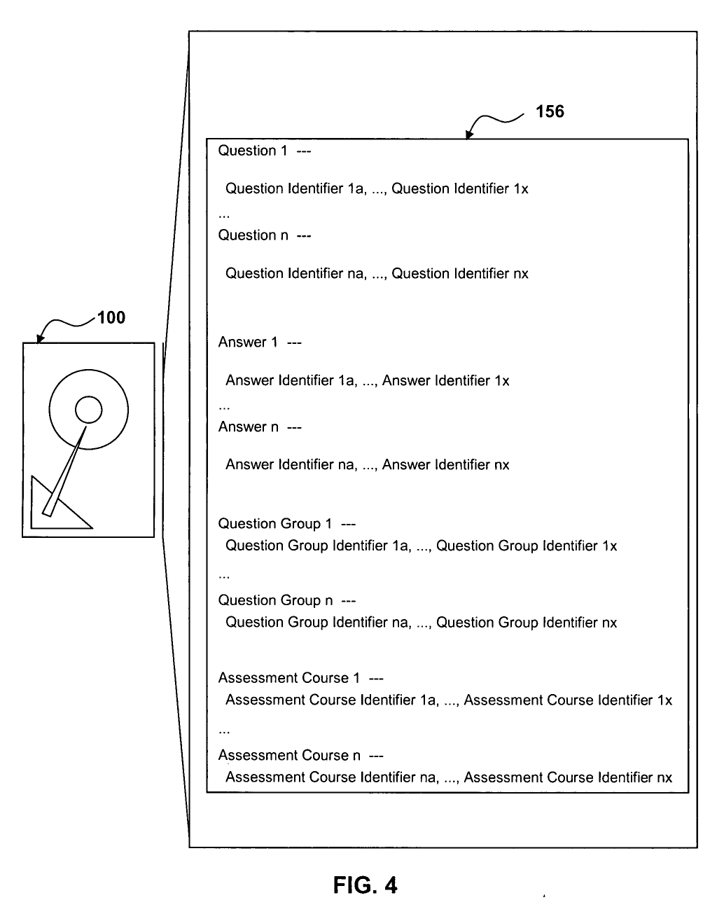

Making reference to FIG. 4, information stored on a storage device 100 for a method of tracking different surveys and questions given to a participant or facility is shown in detail as fourth database 156. This fourth database 156 may be used in place of, or in tandem with, third database 144 shown in FIG. 2. Fourth database 156 stores entries of questions and answers. Matched questions and answers may be stored individually or together. Some or all of the questions and answers are stored with respective question identifiers and answer identifiers. As non-limiting examples, the identifier may be a tracking number or code, or a pointer which logically references another question or answer. Subsets of the plurality of questions and answers are combinable to form a plurality of question groups, which may as non-limiting examples be stored in the database as separate entries, or as collections of pointers which logically reference groups of questions and answers. Each question group entry may include one or more question group identifiers, which again may be tracking numbers or codes, or pointers which logically reference other question groups. These questions groups are themselves combinable to form a plurality of assessment courses, which may as non-limiting examples be stored in the database as separate entries, or as collections of pointers which logically reference groups of question groups, questions, or answers. It should be noted that questions and answers alone may be combinable to form assessment courses, independent of question groups. Each assessment course entry may include one or more question assessment course identifiers, which again may be tracking numbers or codes, or pointers which logically reference other assessment courses.

The question identifiers indicate if an associated question contains similar subject matter to another associated question, the answer identifiers indicate if an associated answer contains similar subject matter to another associated answer, the question group identifiers indicate if an associated question group contains similar subject matter to another associated question group, and the assessment group identifiers indicate if an associated assessment group contains similar subject matter to another associated assessment group. In this way, various surveys can be provided simultaneously to different users, and performance on the various surveys can be correlated and compared by the identifiers, which make clear the logical relationships between the questions, answers, question groups, and assessment courses. If an organization updates its criteria, those facilities that are being evaluated against the old criteria may continue to be so, even while new facilities are being evaluated against the new criteria.

Tracking different versions of questions and surveys can become important when providing questions and surveys to multiple facilities simultaneously. As standard-setting organizations can change their standards at any time, it is clear that two or more versions of a given question or survey may need to coexist; one for those facilities still in the middle of certification by the old standards, and another for those facilities newly seeking certification by the new standards. When providing multiple questions and surveys to multiple labs, an infinite variety of versions, and thus of facility survey configurations, may occur. Accordingly, the above question, answer, question group, and assessment course identifiers allow for a clear and consistent way to freely modify surveys while never losing track of the requirements in place for each facility being tested. The term “similar subject matter” may be used to connote these multiple versions of questions, answers, question groups, or assessment courses, in which the same general concepts are being queried, but the questions, answers, question groups, or assessment courses may differ in the particular manner in which the concept is presented or assessed. As non-limiting examples, this difference may be as simple as the spelling of a word (for example, to correct a typographical error), the ordering of questions in a question group, the order of answers presented to a multiple-choice question, the order of question groups in a assessment course, or even the content of the questions and answers themselves.

Further, the feature of tracking different questions and surveys provides additional flexibility for a surveying organization or other survey provider to adjust and improve questions and surveys for future facilities even while present facilities undergo certification. As a non-limiting example, if a major error is found in a survey question, that question can immediately be changed for all present and future facilities. If a small error is found in a survey question, that question can be changed for future facilities, while present facilities may, for consistency or for other reasons, complete the survey using the original version of the question.

In addition, the feature of tracking different questions and surveys provides the ability to easily test new questions, answers, question groups, or surveys by limited introduction into a random or balanced subset of facilities. In this way, the validity of one or more new metrics can be confirmed before a large-scale rollover to the new metric.

Also, the feature of tracking different questions and surveys allows for multiple questions, question groups, and surveys to be formed based on different sets of standards, and for questions, question groups and surveys which reference old standards to remain available for improvement. Even though new standards may be in place for present facilities, facilities who began the survey process in the past may continue to be held to past standards. As a non-limiting example, if an error is found in survey questions based on the past standards, this error can be corrected for those facilities still being tested under the old standards, without affecting the questions given to those held to the new standards.

Further, the feature of tracking different questions and surveys allows for updating assessment courses. Answers given to an older, first iteration of an assessment course may be stored and scored against new standards corresponding to a newer, second iteration of the same assessment course. The questions, answers, question groups, and even assessment courses of the two iterations are related by identifiers. In this way, one can determine how a facility that has completed an older assessment course might score if given the new assessment course. If it appears from its answers that the facility might no longer be in compliance with the revised standards corresponding to the newer assessment course, recommendations for improvement can be given, and/or the facility can be scheduled for another assessment. Also, systems can be put in place to periodically check stored answers against new iterations of assessment courses, and to automatically alert facilities when they are no longer in compliance.

In addition, the feature of tracking different questions and surveys allows for the determination of a facility's hypothetical score on an assessment course not yet taken. Answers from a completed first assessment course can be used to establish a range of possible scores available for a facility on a second assessment course, by first determining which questions from the second assessment course are answered by answers given in the first assessment course, and then computing the range of possible scores achievable from the remaining unanswered questions of the second assessment course. Aside from the simple determination of the likelihood of passage of the second assessment course, by comparing answers for the first assessment course to questions from a second assessment course, systems can be put in place for a facility to determine which specific modifications would need to be made for the facility to meet the standards of the second assessment course.

In the above examples, it should be noted that question and answer identifiers may be used to establish relationships between questions presented to a facility and those not presented, so that the answer identifiers indicate logical relationships between received answers to questions which were presented and stored answers to questions which were not presented.

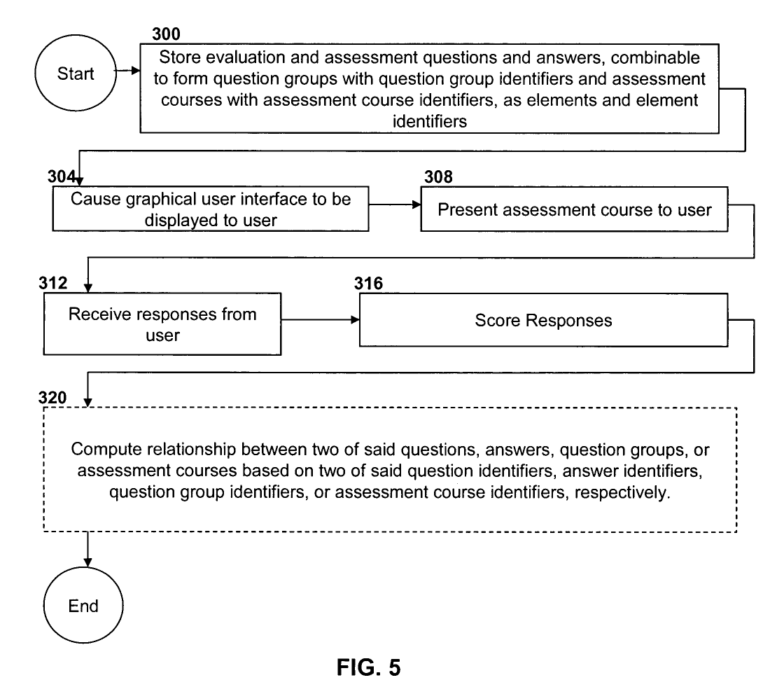

Making reference to FIG. 5, a method is charted for tracking different versions of surveys and questions given to a participant or facility. The method may utilize fourth database 156 of FIG. 4. Importantly, while FIG. 5 illustrates one order of steps for performing the claimed method, other orders may be used, and the order of steps illustrated in FIG. 5 is a non-limiting example. With few exceptions, the claimed methods may be performed in any order of steps, and the invention is defined by the claims and their full scope of equivalence.

The method comprises (step 300) storing a plurality of questions and answers with question identifiers and answer identifiers, wherein subsets of the plurality of questions and answers are combinable to form a plurality of question groups with question group identifiers and are further combinable to form a plurality of assessment courses with assessment course identifiers. The method comprises (step 304) causing a graphical user interface to be displayed, over a communications network, to a user. The method comprises (step 308) presenting to the user, via the graphical user interface, a subset of the plurality of questions comprised by at least one of the plurality of assessment courses, noting that an assessment course may be defined in any manner set forth above. The method comprises (step 312) receiving a plurality of responses from the user to the subset of the plurality of questions comprising the at least one of the plurality of assessment courses. The method comprises (step 316) scoring the plurality of responses based on the answers in order to determine whether the user should receive a certification for the assessment courses.

The method may also optionally comprise (step 320) computing a relationship between two of the questions, answers, question groups, or assessment groups based on two of the question identifiers, answer identifiers, question group identifiers, or assessment course identifiers, respectively. Again, in this way, various versions of a survey can be provided simultaneously to different users, and performance on the various versions can be correlated and compared by the identifiers, which make clear the logical relationships between the questions, answers, question groups, and even assessment courses.

As a non-limiting example, an embodiment of a survey design and tracking method will now be described. Assessment courses, or “surveys,” may be created as a complex set of forms comprising questions, answers, and question groups. A Compendium of Survey Content may be stored from which the survey is able to derive related pieces of text and macros. When developing a survey, a user will create question groups and questions. Every question may have a related piece of survey content for the question text. Questions and question groups may have business rules and attributes, such as a target for the question, that determine how the question should be presented to the user, and consequently how the answer will be displayed in reporting. Every survey may also be classified by survey type. Multiple surveys can be deployed at any given time, but only one of each survey type can be in use at the same time. Finally, a survey can be marked as Deployed or Locked, which define different statuses that the survey can be in during an editing period.

When a deployed survey is to be modified, the survey may go through several review processes before it is published to the facilities. When that survey is published, all facilities that are not currently taking a survey may use the updated version. However, many of the questions that are included in the new survey will have the same meaning or intent as the original. Therefore it is very important to see a history of answers for a question throughout the lifetime of its many changes. The original survey will be archived so that answers to that survey may be retrieved at any time, but changes to the survey may be prohibited.

Accordingly, the data structure of a linked list may be used to accomplish version control, with each node representing a survey. When an initial survey is created it may be given a unique identifier. The identifier is used to distinguish the revision path of each survey. When a user wishes to update a survey, the first step is to branch the original version using duplication. Duplicating a survey causes a new record in the database to be created. The version number may be increased by 1 automatically, and a pointer back to the original survey's unique identifier may be created, as a non-limiting example, in the LastVersionID field. In this way, it can be determined that a given version of a survey is a more recent version of the survey than the original because the LastVersionID points back to the original, while the original survey's LastVersionID is empty, as it is not a duplicate.

Duplicating a survey also may create a new record in the database for each question group, and subsequently each question. As with the survey record, a pointer back to the original question and question group may be placed in the LastVersionID field. Additionally, the identifier of the first question in that history may be placed into the RootVersionID field. This field may be used for faster lookups when presenting the user with question answer data for that question.

The original status of a survey that has been duplicated may be set to “unlocked” and “undeployed.” The survey may be editable when the status is unlocked. When sufficient changes have been made, a user may then lock the survey, preventing changes to it while it goes through rounds of testing. When testing has been completed, the user may either unlock the survey for further editing or deploy the survey to production. The survey will only be accessible outside of the development environment when the survey has been deployed.

Making general reference to the methods, systems, and apparatuses described above, those of skill in the art will understand that information and signals may be represented using any of a variety of different technologies and techniques. For example, data, instructions, commands, information, signals, bits, symbols, and chips which may be referenced throughout the above description may be represented by voltages, currents, electromagnetic waves, magnetic fields or particles, optical fields or particles, or any combination thereof.

Those of skill will further appreciate which the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. “Storage medium” may represent one or more machine readable mediums or devices for storing information. The term “machine readable medium” includes, but is not limited to, wireless channels and various other mediums capable of storing, containing, or carrying instructions and/or data.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Further, one or more of the aspects can be implemented by hardware, software, firmware, middleware, microcode, or any combination thereof. Thus, the present invention is not intended to be limited to the aspects shown herein but is to be accorded the widest scope consistent with the principles and novel features disclosed herein.

Having described the invention in detail and by reference to the aspects thereof, it will be apparent that modifications and variations are possible, including the addition of elements or the rearrangement or combination or one or more elements, without departing from the scope of the invention which is defined in the appended claims.

1) An apparatus for assisting a user in scheduling a plurality of facilities for a survey, the apparatus comprising:
at least one storage device comprising a first database of entries, each entry representing one of said facilities, comprising data representing the geographical location of said facility, and comprising data representing a plurality of ranking factors, said at least one storage device further comprising a second database of entries, each entry representing a surveyor;
at least one computer processor configured to estimate the time it would take for each of said facilities to be surveyed, said at least one computer processor further configured to calculate a ranking for each of said facilities, wherein said ranking is formed from at least one ranking factor, said one or more computer processors further configured to select a subset of facilities based on said ranking;
a display unit capable of representing said subset; and
a human-machine interface, said human-machine interface and said at least one computer processor configured to enable the user to select at least one facility from said subset and add it to a tour list, said human-machine interface and said at least one computer processor further configured the enable the user to schedule an order in which said facilities within said tour list will be visited by at least one surveyor from said second database.

2) The apparatus of claim 1, wherein said display unit is configured to show at least one ranking for each facility in said subset.

3) The apparatus of claim 1, wherein said at least one computer processor comprises two or more computer processors, wherein one of said computer processors is configured to calculate said ranking and another of said computer processors is configured to enable the user to select said at least one facility and to schedule said order.

4) The apparatus of claim 1, wherein said at least one computer processor is further configured to provide a suggested order in which said facilities within said tour list will be visited by at least one surveyor from said second database.

5) The apparatus of claim 1, wherein said at least one ranking factor is selected from the group consisting of: when said selected facility was last surveyed; when said selected facility was last surveyed by a healthcare organization accreditator; an estimate of the time needed to survey said selected facility; if said selected facility is considered Risk of Harm; if a complaint directed toward said selected facility was filed; if said selected facility must be scheduled as soon as possible; if said selected facility must be resurveyed; how much time has passed since said selected facility was entered into said database; if a selected one of said surveyors is permitted to survey said selected facility; if a facility has already been scheduled; the distance from a location of a selected surveyor to the geographical location of said selected facility; what tests need to be performed at said selected facility; and, the availability of systems corresponding to the tests which need to be performed at said selected facility.

6) The apparatus of claim 1, wherein said ranking factors comprise:
when said selected facility was last surveyed;
when said selected facility was last surveyed by a healthcare organization accreditator;
an estimate of the time needed to survey said selected facility;
if said selected facility is considered Risk of Harm;
if a complaint directed toward said selected facility was filed;
if said selected facility must be scheduled as soon as possible;
if said selected facility must be resurveyed;
how much time has passed since said selected facility was entered into said database;
if a selected one of said surveyors is permitted to survey said selected facility;
if a facility has already been scheduled;
the distance from a location of a selected surveyor to the geographical location of said selected facility;
what tests need to be performed at said selected facility; and,
the availability of systems corresponding to the tests which need to be performed at said selected facility.

7) The apparatus of claim 1, further comprising a network access device,
wherein said at least one storage device further comprises a third database storing a plurality of evaluation questions and a plurality of assessment questions, wherein subsets of said pluralities of evaluation and assessment questions are combinable to form at least one assessment course;
wherein said at least one computer processor and said at least one storage device are included in a server,
wherein said at least one computer processor is further configured to cause a graphical user interface to be displayed via said network access device connected to said server and to said communications network;
wherein said at least one computer processor is further configured to present to a remote user terminal, via said graphical user interface, questions comprised by said at least one assessment course;
wherein said at least one computer processor is further configured to receive responses from said remote user terminal to questions comprised by said assessment course; and
wherein said at least one computer processor is further configured to score said plurality of responses in order to determine whether said facility user should receive a certification for said at least one assessment course.

8) The apparatus of claim 1, further comprising:
a synchronizing interface for synchronizing data acquired at a surveyed facility with the entry representing said surveyed facility within said first database of entries.

9) The apparatus of claim 1, the apparatus further comprising:
a customer relationship database stored on said at least one storage device and integrated with one of said first or said second database.

10) The apparatus of claim 1, the apparatus further comprising:
an accounting database stored on said at least one storage device and integrated with one of said first or said second database.

11) A method of assisting a user in scheduling a plurality of facilities for a survey, the method comprising:
providing the user with a first database of entries, each entry representing one of said plurality of facilities, including data representing the geographical location of one of said plurality of facilities, and including data representing a plurality of ranking factors;
estimating the time it would take for each of said facilities to be surveyed;
providing the user with a second database of entries, each entry representing one of a plurality of surveyors;
calculating at least one ranking for at least one of said plurality of facilities, wherein said at least one ranking is formed from at least one of said plurality of ranking factors;
forming a subset of said plurality of facilities based on said at least one ranking;
providing the user with a display representing said subset;
providing the user with an interface to select at least one facility from said subset and add it to a tour list; and
providing the user with an interface to schedule an order in which the facilities from said tour list will be visited by at least one surveyor from said second database.

12) The method of claim 11, further comprising:
storing a plurality of evaluation questions and a plurality of assessment questions, wherein subsets of said pluralities of evaluation and assessment questions are combinable to form a plurality of assessment courses;
causing a graphical user interface to be displayed, over a communications network, to a facility user at a facility selected from within said tour list;
receiving a selection from said facility user, via said graphical user interface, wherein said selection initiates one of said assessment courses;
presenting to said facility user, via said graphical user interface, a subset of said evaluation and assessment questions comprised by said initiated assessment course;
receiving responses from said facility user to the subset of said evaluation and assessment questions; and
scoring said responses in order to determine whether said facility user should receive a certification for said initiated assessment course.

13) The method of claim 12, the method further comprising:
presenting to said facility user, via said graphical user interface, at least one of said plurality of evaluation and assessment questions, wherein said question is selected by at least one of said responses provided by said user.

14) A machine readable medium containing instructions for assisting a user in scheduling a plurality of facilities for a survey according to the method of claim 11.

15) A system for assisting a user in scheduling a plurality of facilities for a survey, the system comprising:
means for storing a first database of entries, each entry representing one of said plurality of facilities, including data representing the geographical location of one of said plurality of facilities, and including data representing a plurality of ranking factors;
means for estimating the time it would take for each of said facilities to be surveyed;
means for storing a second database of entries, each entry representing one of a plurality of surveyors;
means for calculating at least one ranking for at least one of said plurality of facilities, wherein said at least one ranking is formed from at least one of said plurality of ranking factors;
means for forming a subset of said plurality of facilities based on said at least one ranking;
means for displaying said subset;
means for selecting at least one facility from said subset to add to a tour list; and
means for scheduling an order in which the facilities within said tour list will be visited by at least one surveyor from said second database.

16) A method for storing and presenting multiple surveys and questions, the method comprising:
storing questions and answers with question identifiers and answer identifiers, wherein said questions and said answers are combinable to form question groups stored with question group identifiers and are combinable to form assessment courses stored with assessment course identifiers;
causing a graphical user interface to be displayed, over a communications network, to a user;
presenting to said user, via said graphical user interface, a subset of said questions comprised by a first of said assessment courses;
receiving a plurality of responses from said user to said subset of questions; and
scoring said plurality of responses based on answers corresponding to said questions in order to determine whether said user should receive a certification for said first assessment course,
wherein at least one of said question identifiers indicates a logical relationship between a presented first question and a second question,
wherein at least one of said question group identifiers indicate a logical relationship between a first question group and a second question group, and
wherein at least one of said assessment course identifiers indicates a logical relationship between said first assessment course and a second assessment course.

17) The method of claim 16,
wherein at least one of said answer identifiers indicates a logical relationship between a received first answer and a second answer, said second answer stored for a question that was not presented.

18) The method of claim 16,
wherein said first assessment course comprises a first answer, and wherein said second assessment course comprises a second answer, and wherein said first assessment course is an older iteration of said second assessment course, the method further comprising:
computing a score for said second assessment course based on responses from said first assessment course by using one identifier selected from the group consisting of: said question identifiers, said answer identifiers, said question group identifiers, said assessment course identifiers, and combinations thereof.

19) The method of claim 16, the method further comprising:
causing a graphical user interface to be displayed, over a communications network, to a second user; and
presenting to said second user, via said graphical user interface, a subset of said questions comprised by said second assessment course;
wherein said second assessment course assesses the subject matter of the first assessment course, and
wherein said second assessment course and said first assessment course can be presented simultaneously to said second user and said user, respectively.

20) A machine readable medium containing instructions for storing and presenting multiple surveys and questions according to the method of claim 16.
